(19) United States
(12) Patent Application Publication
(10) Pub. No.: US 2020/0275623 A1
(43) Pub. Date: Sep. 3, 2020

(54) HYDROPONIC SYSTEM AND METHOD

(71) Applicant: PURESINSE INC., Toronto (CA)

(72) Inventors: Nader GHESHLAGHI, Thornhill (CA); Malay PANCHAL, Toronto (CA); Vishwas SAWANT, Maple (CA)

(21) Appl. No.: 16/649,839

(22) PCT Filed: Sep. 21, 2018
(86) PCT No.: PCT/CA2018/051189

§ 371 Date: Mar. 23, 2020

(30) Foreign Application Priority Data
Sep. 21, 2017 (CA) 2979715

(51) Int. Cl. A01G 31/02; A01G 25/16; A01G 9/24

(52) U.S. Cl. CPC A01G 31/02; A01G 2031/006; A01G 9/249; A01G 25/165

(57) ABSTRACT

A hydroponics system and method for growing flowering and/or fruiting plants is disclosed that involves a periodic flood and drain system combined with periodic spraying or misting of the plants and appropriate lighting systems and oxygenation systems. Specific flooding, spraying, lighting and oxygenation times and apparatus are disclosed.

### TECHNICAL FIELD

This invention relates to hydroponics systems for growing flowering and fruiting plants.

### BACKGROUND

Hydroponics is used for industrial growing and harvesting of flowering and fruiting plants. At a high level of generality, hydroponics is an approach to growing plants without soil or soilless mediums. Plants are grown by exposing their roots system to a nutrient solution and oxygen while ensuring the plant also receives appropriate lighting. The plants are contained in pots, which may or may not include a substrate (not soil) that is used to hold the plants in an upright position.

Examples of existing systems to provide the nutrient solution and oxygen are the deep water culture (DWC) hydroponic system, the Aeroponic system, and the ebb and flow system. In all cases, a lighting system is used to expose the non-root parts of the plants to appropriate radiation. Each of these systems has a combination of advantages and drawbacks.

In a Deep Water Culture (DWC) system, the roots of the plant are suspended in an oxygenated nutrient solution. Since the roots of the plant stay submerged, it is important that the nutrient solution be sufficiently oxygenated (when plants are grown in soil, the roots obtain oxygen through the natural gaps and holes in the soil in periods of dry conditions. This system has the advantages of being easy to set up and maintain. The nutrient solution may be circulated to ensure a constant level of nutrients, oxygen and temperature in the solution.

In contrast, in the Aeroponic system, the roots are periodically sprayed with a nutrient solution. Oxygenation is not an issue in this approach, since the roots are left to dangle in the air. The spraying can be performed by spraying droplets, but can also be accomplished with misters or foggers to provide smaller droplets. It is important that the nutrient solution be applied in sufficient quantities and timeliness to provide sufficient nutrients to the plant.

In an ebb and flow system, the pots containing the roots of the plant are flooded with a nutrient solution at regular intervals, after which the nutrient solution is allowed to drain so that the roots are left exposed to the air. Generally, the roots obtain oxygen during the part of the cycle where they are exposed to the air, and the roots obtain nutrients during the time they are flooded with nutrient solution.

As a plant grows, it goes through three stages—establishing young seedlings, growing the plant, and then the flowering or fruiting stages. It is usual for the plants to be transferred between three different systems as it grows, with each stage designed to be appropriate to a specific stage of growth.

For a commercial growing operation, the overall cost and the cost per unit yield needs to be optimized. This includes issues such as maximizing the use of growing space; the cost in electricity to run the system, reliability, maintenance and downtime, maximizing yield for the input of nutrients, and ease of setup and use. For example, to enhance productivity in relation to cost in the industrial growing and harvesting context, it is known to use warehouse space or other indoor growing facility for growing operations in three dimensions—in other words, tiers or layers of growing plants are stacked vertically in order to use more of the space in a given warehouse or growing space.

### SUMMARY

To increase the productivity of flowering or fruiting plant cultivation, in a given growing space, the following apparatus and systems were invented. While the system has numerous advantages as discussed in this application, there are two large advantages to be highlighted.

The first is that the need to move plants to different systems as they grown from seedlings to fruiting or flowering plants is eliminated—the plants can be installed in one system that will support them through to maturity. This is particularly significant since a certain percentage of plants are predictably lost, and additional plants are stressed resulting in sub-optimal flowering—due to the process of shifting from one system to another. Eliminating this step eliminates this source of plant stress. In addition, using only one system from seedling through to mature plant reduces the costs in manpower and overall complexity of the operation.

The second is that by improving the growing conditions and thus the health of the plant throughout the growth process, the plants can be made to predictably mature (i.e. flower or fruit) at a lower height than plants grown using traditional systems. This can have very significant advantages in a commercial operation with limited growing space, since more tiers of plants can be put into production, thus increasing productivity for the given space. In addition, healthy maturation of the plant minimizes growth of unwanted parts of the plant, an inefficient use of biomass.

The prior art systems as described in the background have limitations. The Aeroponic method can provide enough oxygen and nutrition, but in actual use the spraying system could be clogged by undissolved chemicals or organic substances. This presents a risk of root damage which subsequently leads to inefficient plant growth. In the early stages of plant growth, in the DWC hydroponic system the seedlings may not have enough root systems to reach the water and nutrient source. In the ebb and flow system, due to the periodic water circulation, while there is enough oxygen available at the drainage stage, the plant does not have access to nutrients; and when nutrient solution is flowing into the growth chamber, the roots do not have an acceptable access to oxygen. The ebb and flow method runs the risk that if the ebb and flow system is interrupted for a significant period of time, the roots do not have adequate access to oxygen or nutrients depending on the state of the system when the breakdown occurred. There is also the possibility of toxic salt buildup and instability of the EC (electrical conductivity, a measure of the dissolved salts in the solution) and pH levels. Too high a level of salt will influence a plant's ability to absorb water from the solution.

The system and methods described in this application are designed to address and control what the inventors believe to be the most important aspects of hydroponics and plant growth: ensuring adequate and well-distributed oxygen for the roots of the plants; ensuring that short roots (as seen in seedling plants) obtain access to nutrients; ensuring that the roots do not end up coated with salts and other impurities; proper lighting; and simplicity and redundancy in design so that the system is easy to set up and maintain and the failure of a minor part (such as a spray head) will not result in deterioration of performance of the system as a whole.

This system may be used for any flowering and/or fruiting plant or strain, including but not limited to Capsicum spp., Abelmoschus spp., Lavandula spp., Hibiscus spp., Solanum laciniatum, Atropa belladonna and Cannabis strains, either pure or hybrid varieties of the Cannabis genus of plants, that encompasses the species Cannabis sativa, Cannabis indica and Cannabis ruderalis. Some of the operating parameters need to be adjusted to reflect the specific characteristics of the specific plant species and strains.

In accordance with the present invention, there is provided a system for growing fruiting or flowering plants comprising: an enclosure with an opening at the top; a lid for the enclosure with at least one net pot pierced therethrough, the lid being sized to close the opening of the enclosure and the net pot being capable of holding a plant; a liquid inlet for feeding a nutrient solution into the enclosure; a liquid outlet for removing said nutrient solution from the enclosure; a liquid nutrient circulation subsystem to circulate said nutrient solution through said enclosure through said liquid inlet and liquid outlet; an oxygenation subsystem to oxygenate the nutrient solution while the nutrient solution is in the enclosure; a spraying subsystem configured to spray the nutrient solution on a plant when said plant is held in the net pot; the liquid nutrient subsystem further comprising a first pump to control the flow rate of said nutrient solution into the enclosure, and a valve connected to the liquid outlet to control the flow rate of said nutrient solution out of the enclosure, and a sensor in the enclosure that can detect if a nutrient solution in the enclosure has reached a set height; a first control system in operative communication with said first pump and said valve and said sensor, said first control system being configured to raise and lower the height of nutrient solution in the enclosure to pre-determined heights at a pre-determined schedule; and a second control system in operative communication with said spraying subsystem, said second control system being configured to activate the spraying subsystem for predetermined lengths of times at a pre-determined schedule.

In another aspect of the present invention, the system further comprises a lighting subsystem. In another aspect of the present invention, the oxygenation subsystem comprises a porous flexible tube configured to oxygenate substantially all of the liquid nutrient when the liquid nutrient is in the enclosure. In another aspect of the present invention, the enclosure is shaped so the top of the enclosure is larger than the bottom of the enclosure. In still another aspect of the present invention, the enclosure is shaped so the top of the enclosure overhangs the bottom of the enclosure on all sides. In another aspect of the present invention, the top of the enclosure and the bottom of the enclosure are each rectangular or square. In another aspect of the present invention, the spraying subsystem comprises at least one spraying nozzle located below the lid of the enclosure. In another aspect of the present invention, the spraying subsystem comprises multiple spraying nozzles located below the lid of the enclosure and situated so that each net pot is sprayed by at least 2 spraying nozzles.

In another aspect of the present invention, the first control system is configured to raise the level of nutrient solution for twenty to forty minutes every two hours, and the second control system is configured to activate the spraying subsystem to: in the seedling stage spray for around 20-40 seconds every five minutes, once the early vegetative stage is reached spray for around 20-40 seconds every 10 minutes, once the pre-flowering stage is reached spray for around 15-30 seconds every thirty minutes, and once the harvesting stage is reached spray for around 5-10 seconds every five minutes. In another aspect of the present invention, the first control system is configured to raise the level of nutrient solution for thirty minutes every two hours, and the second control system is configured to activate the spraying subsystem to: in the seedling stage spray for around 30 seconds every five minutes, once the early vegetative stage is reached spray for around 30 seconds every 10 minutes, once the pre-flowering stage is reached spray for around 20 seconds every thirty minutes, and once the harvesting stage is reached spray for around 10 seconds every five minutes.

In another aspect of the present invention, the spraying subsystem comprises at least one spraying device located above the top of said plant when said plant is held in the net pot. In another aspect of the present invention, the spraying device is a low pressure sprayer. In another aspect of the present invention, the first control system is configured to raise the level of nutrient solution for twenty to forty minutes every two hours, and the second control system is configured to activate the spraying subsystem for around 30 to 120 minutes for every 120 minutes.

In another aspect of the present invention, the first control system is configured to raise the level of nutrient solution for thirty minutes every two hours, the second control system is configured to activate the spraying subsystem for around 30 minutes for every 120 minutes. In another aspect of the present invention, the lighting subsystem is lit for 8-18 hours a day and dark the rest of the day and the light spectrum comprises around 10% green, around 40-60% blue and violet and around 30-50% yellow to red spectrum. In another aspect of the present invention, the lighting subsystem has a light spectrum of around 10% green, around 40-60% blue and violet and around 30-50% yellow to red spectrum and from the seedling up to the flowering stage the lighting is 18 hours of light and 6 hours of dark per day, and at the flowering stage through harvesting the lighting is 12 hours of light and 12 hours of dark per day. In another aspect of the present invention, the spraying subsystem comprises at least one spraying device located to be near the crown of said plant when said plant is held in the net pot. In another aspect of the present invention, the spraying device is a dripper ring. In another aspect of the present invention, the spraying device is a low pressure sprayer.

In another aspect of the present invention, there is provided a system for growing fruiting or flowering plants comprising a plethora of systems as described above, where the liquid nutrient is pumped from a reservoir through the plethora of systems and back into the reservoir. In another aspect of the present invention, there is provided a plethora of systems as described above, where the liquid nutrient is pumped from a reservoir through the plethora of systems in series and back into the reservoir.

In accordance with the present invention, there is provided a method for growing fruiting or flowering plants comprising: placing at least one seedling of a plant in a net pot in an hydroponics apparatus, where the hydroponics apparatus comprises: an enclosure with an opening at the top; a lid for the enclosure with at least one net pot pierced therethrough, the lid being sized to close the opening of the enclosure and the net pot being capable of holding a plant; a liquid inlet for feeding a nutrient solution into the enclosure; A liquid outlet for removing said nutrient solution from the enclosure; a liquid nutrient circulation subsystem to circulate said nutrient solution through said enclosure through said liquid inlet and liquid outlet; an oxygenation subsystem to oxygenate the nutrient solution while the nutrient solution is in the enclosure; a spraying subsystem configured to spray the nutrient solution on a plant when said plant is held in the net pot; the liquid nutrient subsystem further comprising a first pump to control the flow rate of said nutrient solution into the enclosure, and a valve connected to the liquid outlet to control the flow rate of said nutrient solution out of the enclosure, and a sensor in the enclosure that can detect if a nutrient solution in the enclosure has reached a set height; a first control system in operative communication with said first pump and said valve and said sensor; a second control system in operative communication with said spraying subsystem, and a lighting subsystem; where said first control system is configured to raise and lower the height of nutrient solution in the enclosure to pre-determined heights at a pre-determined schedule such that the roots of the seedling are substantially covered when the nutrient solution in the enclosure is at its highest point; and said second control system being configured to activate the spraying subsystem for predetermined lengths of times at a pre-determined schedule.

In another aspect of the present invention, the configuration of the first control system and the configuration of the second control system are varied with the growth stage of the plant. In another aspect of the present invention, the first control system is configured to raise the level of nutrient solution for twenty to forty minutes every two hours, and the second control system is configured to activate the spraying subsystem to: in the seedling stage spray for around 20-40 seconds every five minutes, once the early vegetative stage is reached spray for around 20-40 seconds every 10 minutes, once the pre-flowering stage is reached spray for around 15-30 seconds every thirty minutes, and once the harvesting stage is reached spray for around 5-10 seconds every five minutes. In another aspect of the present invention, the first control system is configured to raise the level of nutrient solution for thirty minutes every two hours, and the second control system is configured to activate the spraying subsystem to: in the seedling stage spray for around 30 seconds every five minutes, once the early vegetative stage is reached spray for around 30 seconds every 10 minutes, once the pre-flowering stage is reached spray for around 20 seconds every thirty minutes, and once the harvesting stage is reached spray for around 10 seconds every five minutes. In another aspect of the present invention, the first control system is configured to raise the level of nutrient solution for twenty to forty minutes every two hours, and the second control system is configured to activate the spraying subsystem for around 30 to 120 minutes for every 120 minutes. In another aspect of the present invention, the first control system is configured to raise the level of nutrient solution for thirty minutes every two hours, the second control system is configured to activate the spraying subsystem for around 30 minutes for every 120 minutes. In another aspect of the present invention, the lighting subsystem is lit for 8-18 hours a day and the light spectrum comprises around 10% green, around 40-60% blue and violet and around 30-50% yellow to red spectrum. In another aspect of the present invention, the method of claim 22, where the lighting subsystem has a light spectrum of around 10% green, around 40-60% blue and violet and around 30-50% yellow to red spectrum and from the seedling up to the flowering stage the lighting is around 18 hours of light and around 6 hours of dark per day, and at the flowering stage through harvesting the lighting is around 12 hours of light and around 12 hours of dark per day. In another aspect of the present invention, the plants are not moved from one growing location to another during the growth of the plant from seedling to harvesting. In another aspect of the present invention, the humidity is kept between 55% and 75%, the ambient temperature between 24° C. to 29° C., and the nutrient solution's pH is kept between 5.8 and 6.3, and the temperature of the nutrient solution is kept between 17° C. to 19° C.

In accordance with the present invention, there is provided a method for growing fruiting or flowering plants comprising: substantially immersing the roots of the plant in a nutrient solution on a first periodic basis while oxygenating the nutrient solution, while spraying the roots of the plant on a second periodic basis when the roots are not immersed and while lighting the plant on a third periodic basis.

In another aspect of the present invention, the first periodic basis and the second periodic basis are varied with the growth stage of the plant. In another aspect of the present invention, the first periodic basis and the second periodic basis are varied with the growth stage of the plant and are chosen to reflect the species and strain of the plant. In another aspect of the present invention, the first periodic basis comprises substantially immersing the roots of the plant for twenty to forty minutes every two hours, and the second periodic basis comprises: using a micro-sprayer nozzle, in the seedling stage spraying for around 20-40 seconds every five minutes, once the early vegetative stage is reached spraying around 20-40 seconds every 10 minutes, once the pre-flowering stage is reached spraying around 15-30 seconds every thirty minutes, and once the harvesting stage is reached spraying around 5-10 seconds every five minutes. In another aspect of the present invention, the first periodic basis comprises substantially immersing the roots of the plant for thirty minutes every two hours, and the second periodic basis comprises: using a micro-sprayer nozzle, in the seedling stage spraying for around 30 seconds every five minutes, once the early vegetative stage is reached spraying around 30 seconds every 10 minutes, once the pre-flowering stage is reached spraying around 20 seconds every thirty minutes, and once the harvesting stage is reached spraying around 10 seconds every five minutes.

In another aspect of the present invention, the first periodic basis comprises substantially immersing the roots of the plant for twenty to forty minutes every two hours, and the second periodic basis comprises: using an irrigation misting micro flow low pressure sprayer head, spraying for around 30 to 120 minutes for every 120 minutes. In another aspect of the present invention, the first periodic basis comprises substantially immersing the roots of the plant for thirty minutes every two hours, and the second periodic basis comprises: using an irrigation misting micro flow low pressure sprayer head, spraying for around 30 minutes for every 120 minutes. In another aspect of the present invention, the plants are not moved from one growing location to another during the growth of the plant from seedling to harvesting. In another aspect of the present invention, the humidity is kept between 55% and 75%, the ambient temperature between 24° C. to 29° C., and the nutrient solution's pH is kept between 5.8 and 6.3, and the temperature of the nutrient solution is kept between 17° C. to 19° C.

In accordance with the present invention, a method of growing fruiting or flowering plants is provided comprising: substantially immersing the roots of the plants in a nutrient solution on a predetermined schedule; spraying the roots of the plant while the roots are not immersed on a second pre-determined schedule; and exposing the plants to a light spectrum. In an aspect of this invention, the step of substantially immersing the roots of the plants in a nutrient solution on a predetermined schedule further comprises substantially immersing the roots of the plants in a nutrient solution for thirty minutes every two hours; and the step of spraying the roots of the plant while the roots are not immersed on a second pre-determined schedule comprises: spraying the roots of the plant for around 30 seconds every five minutes while the plant is in the seedling stage; spraying the roots of the plant for around 30 seconds every ten minutes while the plant is in the early vegetative stage; spraying the roots of the plant for around 20 seconds every thirty minutes while the plant is in the pre-flowering stage; and spraying the roots of the plant for around 10 seconds every five minutes while the plant is in the harvesting stage.

In a further aspect of the present invention, the method further comprises: exposing the plants to a light spectrum comprising around 10% green, around 40-60% blue and violet and around 30-50% yellow to red spectrum.

In a further aspect of the present invention, the method further comprises: the plants being exposed to the light spectrum for 8-18 hours a day. In a further aspect of the present invention, the plants are exposed to the light spectrum for around 18 hours a day when the plants are in the seedling through to the flowering stage and are exposed to the light spectrum for around 12 hours a day when the plants are in the flowering stage through harvesting. In a further aspect of the present invention, the plants are kept in an environment where the humidity is kept between 55% and 75%, the ambient temperature between 24° C. to 29° C., and the nutrient solution's pH is kept between 5.8 and 6.3, and the temperature of the nutrient solution is kept between 17° C. to 19° C.

In accordance with the present invention, there is provided a system for growing fruiting or flowering plants comprising: a conduit with at least one net pot pierced through the top of the conduit, the net pot being capable of holding a plant; a liquid inlet for feeding a nutrient solution through the conduit and a liquid outlet for removing said nutrient solution from the conduit; a liquid nutrient circulation subsystem to circulate said nutrient solution through said co conduit through said liquid inlet and liquid outlet;

an oxygenation subsystem to oxygenate the nutrient solution while the nutrient solution is in the conduit; a spraying subsystem configured to spray the nutrient solution on a plant when said plant is held in the net pot; the liquid nutrient subsystem further comprising a first pump to control the flow rate of said nutrient solution into the conduit, and a valve connected to the liquid outlet to control the flow rate of said nutrient solution out of the conduit, and a sensor in the conduit that can detect if a nutrient solution in the conduit has reached a set height; a first control system in operative communication with said first pump and said valve and said sensor, said first control system being configured to raise and lower the height of nutrient solution in the conduit to pre-determined heights at a pre-determined schedule; and a second control system in operative communication with said spraying subsystem, said second control system being configured to activate the spraying subsystem for predetermined lengths of times at a pre-determined schedule.

In a further aspect of the invention, the system further comprises a lighting subsystem. In another aspect of the invention, the lighting subsystem is located to the side of the conduit. In another aspect of the invention, the oxygenation subsystem comprises a porous flexible tube configured to oxygenate substantially all of the liquid nutrient when the liquid nutrient is in the conduit. In another aspect of the invention, the system of claim 47 where the first control system is configured to raise the level of nutrient solution for twenty to forty minutes every two hours, and the second control system is configured to activate the spraying subsystem to: in the seedling stage spray for around 20-40 seconds every five minutes, once the early vegetative stage is reached spray for around 20-40 seconds every 10 minutes, once the pre-flowering stage is reached spray for around 15-30 seconds every thirty minutes, and once the harvesting stage is reached spray for around 5-10 seconds every five minutes. In another aspect of the invention, the system of claim 47 where the first control system is configured to raise the level of nutrient solution for thirty minutes every two hours, and the second control system is configured to activate the spraying subsystem to: in the seedling stage spray for around 30 seconds every five minutes, once the early vegetative stage is reached spray for around 30 seconds every 10 minutes, once the pre-flowering stage is reached spray for around 20 seconds every thirty minutes, and once the harvesting stage is reached spray for around 10 seconds every five minutes.

### BRIEF DESCRIPTION OF THE DRAWINGS

In order to better understand various exemplary embodiments, reference is made to the accompanying drawings, wherein:

FIG. 1 is a cross-sectional view of the first embodiment of the enclosure and related apparatus;

FIG. 2a is a cross sectional view of several enclosures with tapering sides;

FIG. 2b is a plan view of the enclosure of FIG. 2a;

FIG. 2c is a bottom view of the enclosure of FIG. 2a;

FIG. 3 is a plan view without lid illustrating the oxygenation system;

FIG. 4 is a plan view with lid illustrating a below-lid spraying subsystem;

FIG. 5 is a plan view with lid illustrating a top spray spraying subsystem;

FIG. 6 is a cross-sectional view of a pot with a plant illustrating the location for a dripper ring spraying subsystem;

FIG. 7 is a cross-sectional view of a specific embodiment of the enclosure and apparatus;

FIG. 8 is a cross-sectional view of a net pot;

FIG. 9 is an illustration of the circulation of the nutrient solution in series through multiple enclosures;

FIGS. 10a, 10b and 10c show the results of tests growing plants with a DWC control system (FIG. 10a), the inventive system with a top spray subsystem (FIG. 10b) and the inventive system with a pressure spray system from below the lid of the enclosure (FIG. 10c);

FIG. 11a is a table showing the results of tests measuring the average plant growth, growing plants with a DWC control system (labelled NA), the inventive system with a top spray subsystem (labelled TS), the inventive system with a pressure spray system from below the lid of the enclosure (labelled PS), and the inventive system with a drip ring located above the lid of the enclosure (labelled TD);

FIG. 11b is a graph charting the results in table 10a;

FIG. 12a is a table showing the results of tests measuring the quality of vegetative growth rate and the root quality and growth rate, growing plants with a DWC control system (labelled NA), the inventive system with a top spray subsystem (labelled TS), the inventive system with a pressure spray system from below the lid of the enclosure (labelled PS), and the inventive system with a drip ring located above the lid of the enclosure (labelled TD);

FIG. 12b is a graph charting the results for the quality of vegetative growth rate in table 12a;

FIG. 12c is a graph charting the results for the root quality and growth rate in table 12a;

FIG. 13 is a cross-section of a conduit with net pots.

FIG. 14a is a top view of a conduit, illustrating on offset arrangement of net pots;

FIG. 14b is a top view of a conduit, illustrating a second arrangement of net pots; and

FIG. 15 is an illustration of one arrangement of a stack of conduits.

### DETAILED DESCRIPTION

The system involves an enclosure, with an opening at the top that is covered by a lid. The lid is pierced by at least one net pot, suitable for holding a flowering or fruiting plant. A liquid inlet and a liquid outlet are pierced through the enclosure, and are connected to a reservoir of nutrient solution and pumps to allow the level of nutrient solution in the enclosure to be raised and lowered, typically though not necessarily through use of nutrient level control sensors and a control program. An oxygenation subsystem is located in the enclosure to oxygenate the nutrient solution evenly. A spraying subsystem is provided, either outside or inside the enclosure, to spray nutrient solution on the plants, in a specific embodiment on the roots. Finally, a lighting system is provided, to be located above the enclosure and lid to provide lighting to the plants.

In a particular embodiment, the level of nutrient in the enclosure is raised and lowered by a control subsystem according to a schedule. Similarly, the spraying subsystem is controlled by a control subsystem and sprays the plants according to a predetermined schedule. While these can be two separate control systems, more typically there would be one control subsystem controlling both the level of nutrient solution in the enclosure and the spraying subsystem.

The lighting is chosen to provide specific spectrum recipes reflecting the type or strain of plant being grown. In a particular embodiment, the lighting is provided by adjustable light spectrum LED lights. The nutrient mixture is chosen to reflect the type of plant and/or strain of plant, and also the stage of the plant's growth. (It should be noted that if problems are noted with the growing plants, the nutrient mix can be changed to compensate) Similarly, while the temperature and humidity are not closely controlled, the temperature and humidity should be within ranges that are suited to the specific plant and/or strain.

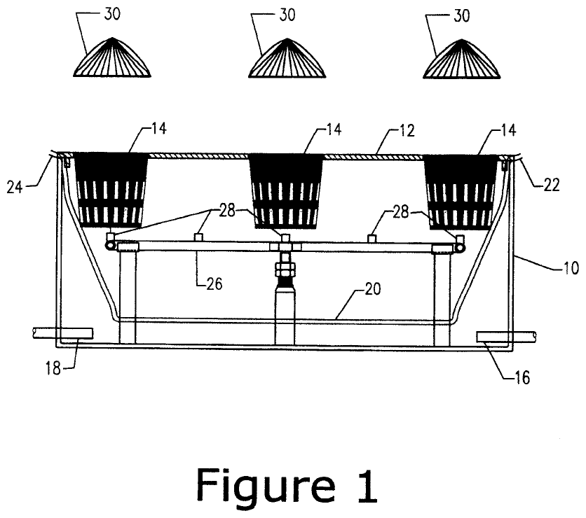

Turning to FIG. 1, there is an enclosure 10 with an open top that matches with a lid 12. Pierced through the lid is at least one net pot 14. The enclosure has a liquid inlet 16 and a liquid outlet 18. There is also an oxygenation system 20, which is pierced through the enclosure at oxygenation inlet 22 and oxygenation outlet 24.

Although in FIG. 1, the liquid inlet 16 and the liquid outlet 18 are illustrated as pierced through the enclosure, in an alternative embodiment one or more of the liquid inlet 16 liquid outlet 18 are pierced through the lid 12. Similarly, although in FIG. 1, the oxygenation inlet 22 and oxygenation outlet 24 are illustrated as pierced through the joint of the enclosure wall and the lid, in alternative embodiments one or more of the oxygenation inlet 22 and oxygenation outlet 24 are pierced through the lid 12 and/or through the enclosure wall.

The system also has a spraying sub system. Turning to FIG. 1, the spraying system 26 is illustrated as located inside the enclosure with spray heads 28 located amongst the at least one net pots 14. As discussed below, there are several possible embodiments of the spraying system that may be utilized depending on the plant and/or the strain of the plant to be grown.

For embodiments of the spraying subsystem located inside the enclosure, in one embodiment the system uses micro-sprayer nozzles (with a 360 Degree Micro Spray Pattern. Soft, Coarse Threads; Flow Rates: 31.4 GPH at 20 PSI, 11/64 drill or screw onto ¼″ tubing).

Generally, in this embodiment lid 12 and pots 14 are designed to minimize if not eliminate the spraying liquid from splashing outside the enclosure or wetting the upper parts of the plants.

The system described above is utilized in conjunction with a lighting system 30.

In operation, the level of nutrient solution in the enclosure is periodically raised to flood the at least one net pots 14—i.e. raising the level of nutrient solution to cover at least a portion of the bottom part of the net pots 14 below the lid 12—and then periodically drained to a lower level than the spray heads 28 and lower than the bottom of the net pots 14. At all times, the nutrient solution in the enclosure is oxygenated by oxygenation system 20. During periods when the level of the nutrient solution is below the spray heads 28, the spraying system 26 is activated for discrete periods to spray the net pots 14 and thus the roots of plants located in net pots 14. Simultaneously, the spectrum recipe of lighting system 30 is set to benefit the specific plant and/or strain of plant being grown.

This approach can accommodate plants throughout their growth cycle from seedlings to mature flowering or fruiting plants. It is important that in the early stages of growth, the flooding of the pots 14 should raise the level of nutrient solution to cover the roots of the seedlings.

There are several embodiments to the apparatus and methods disclosed above.

FIG. 1 has disclosed a single enclosure. In practice, a number of enclosures will be abutted to create a continuous growing surface with multiple enclosures, lids and pots. To allow an efficient abutting of lids and enclosures, in a second embodiment the lid 12 is, when seen from the top, a regular polygon allowing for complete coverage of an area, such as a square, rectangle, or hexagon. In a preferred embodiment the lid 12 is, when seen from the top, a rectangle or square.

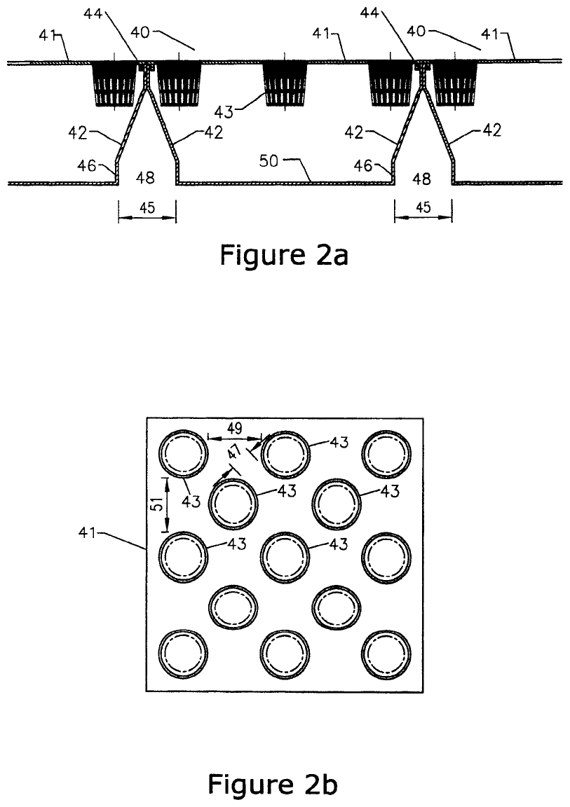

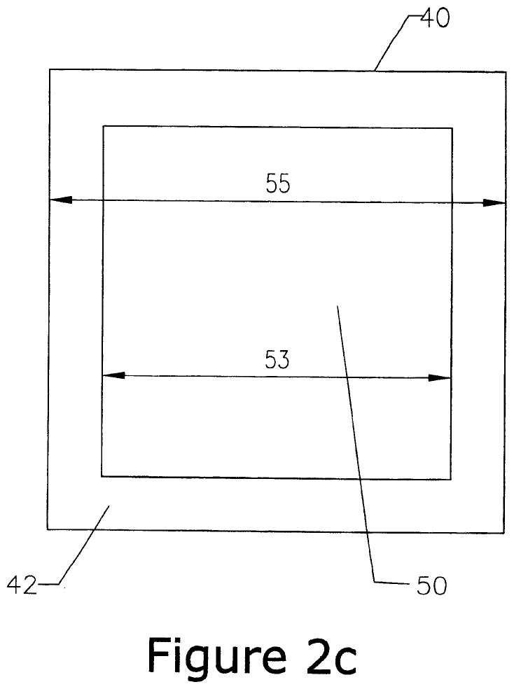

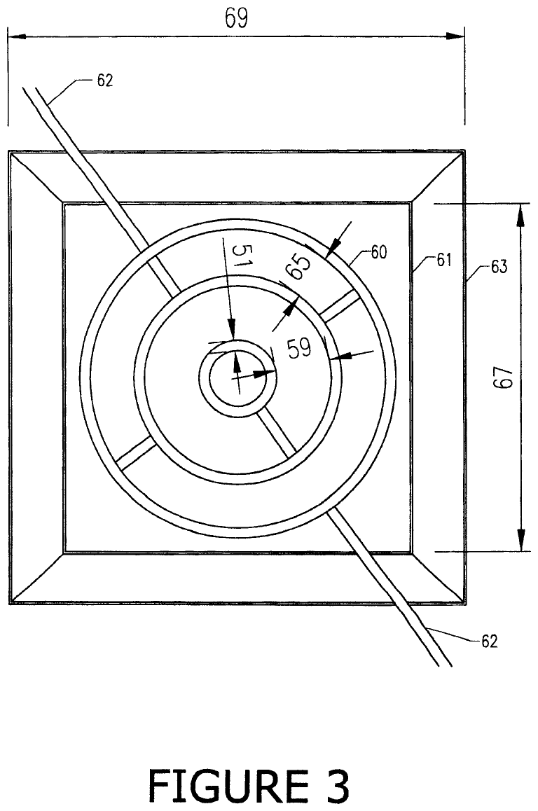

In a preferred embodiment, the lower part of the enclosure is slanted inwards so that the top of the enclosure (or equivalently, the lid) overhangs the bottom of the enclosure. Such an embodiment is illustrated in FIGS. 2a-2c. Turning to FIG. 2a, the enclosure 40 has a tapering section 42 between a top section 44 and base 46. FIG. 2b is a top view that shows the lid 41 for enclosure 40 with net pots 43. In the specific embodiment illustrated in FIGS. 2a-2c, the enclosure and lid are square. FIG. 2c is a bottom view of the enclosure. It may be seen that the top of the enclosure overhangs the bottom surface 50 of the enclosure 40.

When multiple enclosures with overhang, such as enclosure 40, abut, spaces 48 (as seen in FIG. 2a) are created. Spaces 48 create a network of open channels through the abutting enclosures 40, and can be used to run and access piping, pumps, and control devices. This can have significant improvements in terms of overall efficiency in the system since the space saved by running piping and support systems through spaces 48 can instead be used for additional growing space. The channels created by spaces 48 also allow air circulation through a set of abutted enclosures 40, which aids in keeping the temperature, humidity and oxygen levels throughout the growing system stable. The use of a tapering section 42 also allows the system to economize on the volume of nutrient solution that needs to be added to fill the enclosure. This reduces the weight of the total growing system.

The oxygenation subsystem needs to provide an adequate level of oxygenation to the nutrient solution in the enclosure. Traditionally, this has been accomplished through the use of air-stones. In a preferred embodiment of the inventive system, the oxygenation system is provided by a flexible porous tube, which is connected to an air pump. FIG. 3 shows a top view of this oxygenation system. Turning to FIG. 3, it may be seen that oxygenation system 60 is fed by air supply pipes 62, and is generally spiral or circular in design, substantially covering the base 61 of the square enclosure 63. This creates many small bubbles rather than a slow stream of localized larger bubbles. Covering the base in this manner produces uniformity in the oxygenation of the nutrient solution, resulting in healthier roots and uniformity in plant growth.

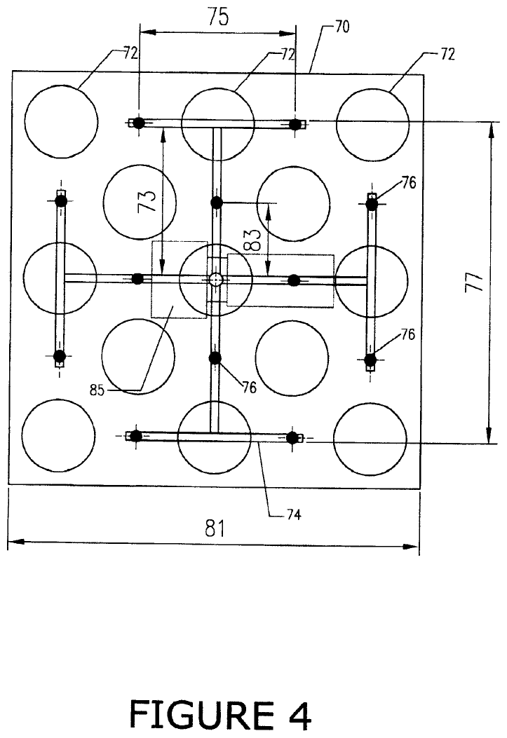

In the system illustrated in FIG. 1, the spraying subsystem 26 with spray heads 28 are fitted between the pots 14. A top view of such a system is illustrated in FIG. 4. Turning to FIG. 4, there is a lid 70 provided with thirteen pots 72. Spraying subsystem 74 connects spray heads 76, which are located between pots 72. When activated, spray heads 76 spray the plants in pots 72 from multiple sides. As a result, even if a specific spray head malfunctions, the plants should still receive an adequate spray from the other nearby spray heads.

The amount of spraying should be sufficient to wash away salt and other deposits from the root system. While spraying with a nutrient solution is preferred, and spraying with the same nutrient solution that is used for immersing the roots is most preferred, it is possible to spray with water or other liquids, as long as salt or other deposits are washed from the root system.

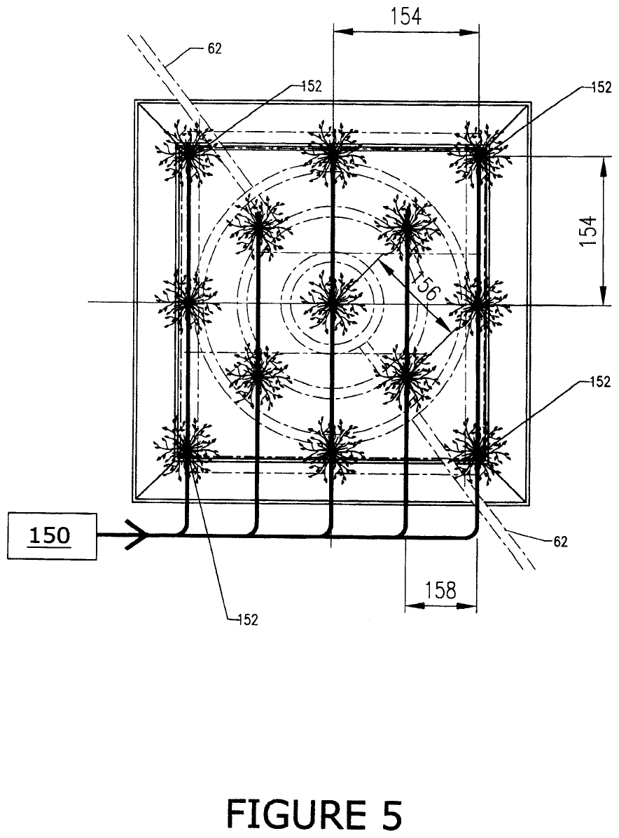

In another embodiment, the spraying subsystem sprays from the top (above the lid). Turning to FIG. 5 a water pump 150 located inside the enclosure supplies spray heads 152. In a particular embodiment, sprayer 152 can be a low pressure sprayer nozzle. In a particular embodiment, the sprayers 152 are an irrigation misting micro flow low pressure sprayer head (for example but not limited to an ¼″ Hose-PY, high quality 8 spray hole, with a ¼ inch threaded barb connection, clog resistant and has a water flow control knob (adjustable spraying distance) which allows a PSI of 25 with a flow rate from 1 to 16 gallons per hour; connection: ¼\′\′ hose ID 4 mm/OD 7 mm).

Either the dripper ring or the low pressure sprayer nozzle requires less pressure for operation than a typical spray nozzle (such as would be used in the system illustrated in FIG. 1) and thus requires a less powerful water pump, or if the nutrient reservoir is located higher than the nozzle no water pump at all, saving operating costs.

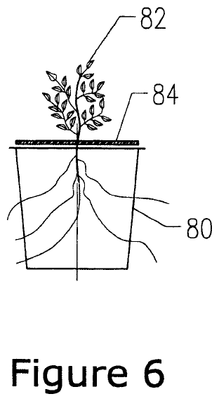

In another embodiment, the spraying subsystem uses a dripper ring. Turning to FIG. 6, pot 80 holds a plant 82. Around the main stem of the plant 82 and close to the root system is a sprayer 84. In this illustration, sprayer 84 is a dripper ring made from a flexible porous tube, but other sprayers or misters could be used. In a particular embodiment, sprayer 84 can be a low pressure sprayer nozzle. Either the dripper ring or the low pressure sprayer nozzle requires less pressure for operation than a typical spray nozzle and thus requires a less powerful pump, or if the nutrient reservoir is located higher than the nozzle no pump at all, saving operating costs.

In all of the embodiments disclosed in this application, the enclosure and lid are made of sufficiently strong and resilient material to allow the enclosures to be reused many times. The inside of the enclosures and bottom of the lids are either manufactured out of a dark material or painted with dark colour paint to prevent any light entry to disturb the plant root area. The top surface of the lids are painted with white colour paint to increase light reflection to the plants.

As discussed above, the entire system is managed by a control system, whether a single comprehensive control system or several control systems for the spray, lighting and nutrient solution subsystems.

In one embodiment, the enclosure is flooded for thirty minutes every two hours (i.e. the enclosure is flooded from 1200-1230, and then drained to the lower level, and then flooded again at 1400). The time can be optimized for individual plant species and/or strains, however, flooding times ranging from 20 to 40 minutes for every two hours will work.

The spray times can be designed to reflect for the type of plant (species and/or strain) and the plant growth stage. As is standard and known to persons in the art, the growth of a plant goes through the following stages: seedling, vegetative, flowering, fruiting, and harvesting.

In one embodiment, using a micro-sprayer nozzles (for example but not limited to a 360 degree micro spray pattern, soft, with coarse threads; flow rates: 31.4 GPH at 20 PSI, 11/64 drill or screw onto ¼″ tubing), in the seedling stage the spray lasts for around 30 seconds every five minutes, once the early vegetative stage is reached the spraying is adjusted to around 30 seconds every 10 minutes, and once the pre-flowering stage is reached the spray is adjusted to around 20 seconds every thirty minutes, and this spray level is used until harvesting, at which point the spray is changed to around 10 seconds every five minutes. In the case where the sprayers are located below the net pots, the spraying only occurs during times when the sprayer nozzles are above the level of the nutrient solution. These spray timings work for a wide range of plant species and strains.

The following ranges should work with a wide range of plant species and strains: using a micro-sprayer nozzles (for example but not limited to a 360 degree micro spray pattern, soft, coarse threads; flow rates: 31.4 GPH at 20 PSI, 11/64 drill or screw onto ¼″ tubing), in the seedling stage the spray lasts for around 20-40 seconds every five minutes, once the early vegetative stage is reached the spraying is adjusted to around 20-40 seconds every 10 minutes, and once the pre-flowering stage is reached the spray is adjusted to around 15-30 seconds every thirty minutes, and this spray level is used until harvesting, at which point the spray is changed to around 5-10 seconds every five minutes.

In the case of a top sprayer (as seen in FIG. 5), longer spraying times are used, In one embodiment, using irrigation misting micro flow low pressure sprayer heads (for example but not limited to ¼″ Hose-PY, high quality 8 spray hole, with a ¼ inch threaded barb connection this water low pressure sprayer, clog resistant and with a water flow control knob (adjustable spraying distance) which allows a PSI of 25 with a flow rate from 1 to 16 gallons per hour; connection: ¼\′\′ hose ID 4 mm/OD 7 mm), the spray times average to 30 minutes of spray for every 120 minutes. In another embodiment, the spraying can range from 30 to 120 minutes (i.e. continuous spray) for every 120 minutes.

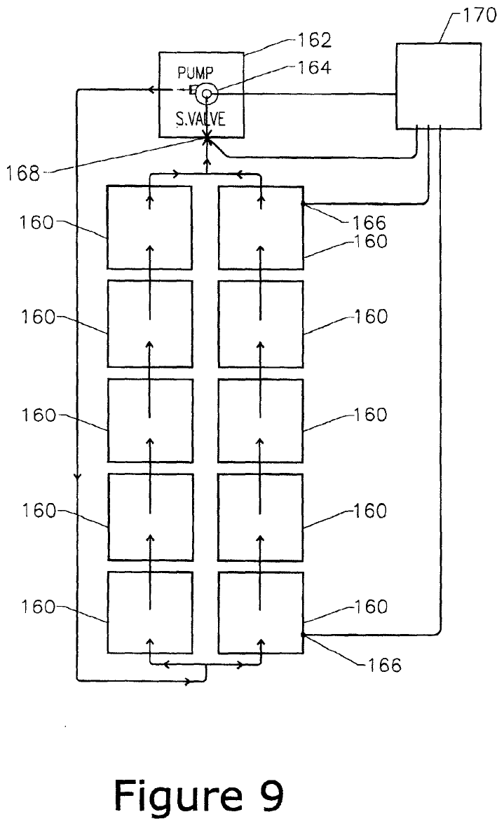

The liquid nutrient circulates from a reservoir through the bulk space of the enclosures themselves. Turning to FIG. 9, there are several enclosures 160. Nutrient solution is pumped from a nutrient reservoir 162 by pump 164 in series, as shown by the arrows. While the nutrient solution is illustrated as circulating in series, the solution may also circulate in parallel. Nutrient reservoir 162, or a supplemental nutrient reservoir, may be placed in a high location, including above all of the enclosures 160, to take advantage of gravity in the spraying and circulatory systems.

At least one of the enclosures 160 is equipped with a sensor 166, which communicates with a control system 170. Control system 170 is in communication with and controls pump 164 and valve 168. In operation, to raise the level of nutrient solution in the enclosures, valve 168 is closed and pump 164 is engaged until the level of the nutrient solution reaches sensor(s) 166. At that point, pump 164 is disengaged. After a set period of time, the level of nutrient solution in the enclosures is lowered by opening vale 168 (and, depending on the location of the reservoir 162, the nutrient solution drains by gravity). Once a set period of time has passed, pump 164 is re-engaged to maintain the level of nutrient solution in the enclosures. Alternatively, once a second sensor (not illustrated in FIG. 9) detects that the nutrient solution has lowered to the desired point in the enclosures 160, pump 164 is re-engaged to maintain the level of nutrient solution in the enclosures. A person skilled in the art will recognize that additional sensors can be added to this basic system to monitor the levels of nutrient solution in all enclosures 160, and/or to turn pump 164 on and off and open and shut valve 168 based on some average or other analysis of the set of sensors.

The humidity in the growing room should be kept between 55% and 75%, and the temperature between 24° C. to 29° C. The nutrient solution's pH should be kept between 5.8 and 6.3, and the temperature between 17° C. to 19° C. (generally, the temperature of the nutrient solution should be low enough to encourage dissolving of the oxygen into the nutrient solution, where it will be accessed by the plant roots). Air circulation should be maintained by methods known to those in skilled in the art, such as the use of fans. The air pump supplying the oxygenation system should run continuously. In a first embodiment, the light was adjusted to have 18 hours a day of light and 6 hours of dark. Generally, the ratio of light to dark times depends on the plant (species and/or strain), but ranges between 8-18 hours a day for light. For Cannabis, at the seedling up to the flowering stage the lighting is 18 hours of light/6 hours of dark, and at the flowering stage through harvesting is 12 hours of light/12 hours of dark.

The nutrient solution should vary as the plant grows, depending upon the plant type and/or strain. Initially and generally, only water is used at the seedling stage for a day or two, and thereafter nutrients are added to the solution until a maximum nutrient dose is reached, which is maintained through harvest. This can be adjusted by the operator depending upon his observation of the health of the actual plants. The amount of nutrients to be added and the rate of addition depend on the type of nutrient being added (i.e. the nutrient mix) and the plant strain and/or species.

In one embodiment, for the first two days, only water is circulated, then for a few days nutrient is added keeping the TDS at less than around 200 ppm. Once the vegetative stage is reached, the TDS is increased to around 300 ppm, and when the pre-flowering stage is reached the nutrient level is adjusted to a TDS of around 450 ppm.

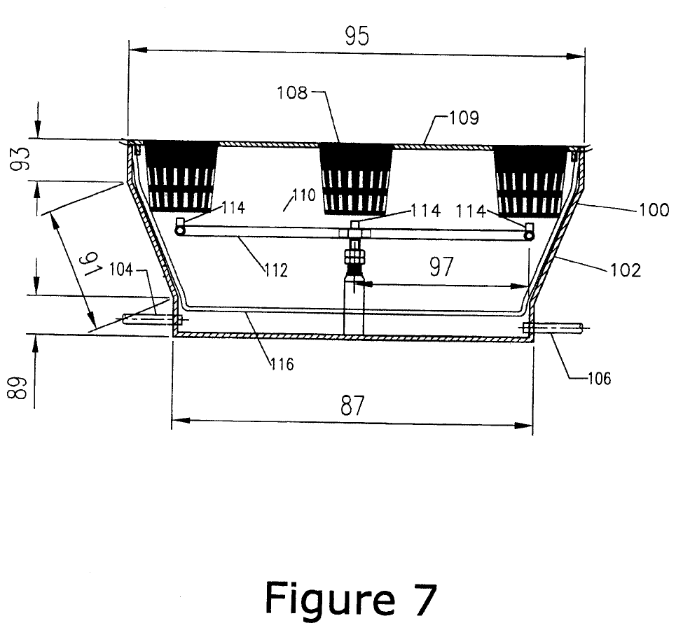

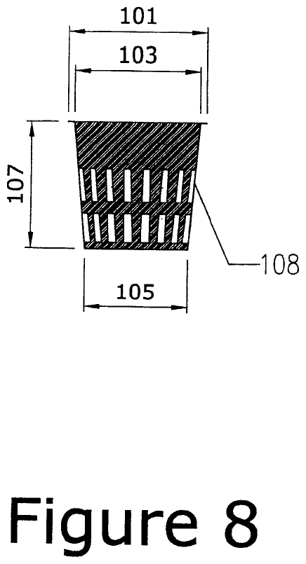

In a specific embodiment, turning to FIG. 7, each enclosure 100 has the same shape and square configuration as seen in FIGS. 2a through 4, with a taper 102 and is made out of acrylic plastic, fibreglass or any solid material. Liquid inlet 104 and liquid outlet 106 are 1¼″ PVC pipe designed to be used with a flexible coupling. Lid 109 has 13 pots 108. Turning to FIG. 8, pot 108 has a top diameter 101 of 108 mm, an inner top diameter 103 of 98 mm, a bottom diameter 105 of 80 mm, and a height 107 of 98 mm. Turning to FIG. 7, the lid has a length 95 of 610 mm, the bottom of the enclosure has a length 87 of 483 mm, the walls of the enclosure have a lower section 89 that is 51 mm long, tapered section with a length 91 of 165 mm, and an upper section of length 93 of length 57 mm. Turning to FIG. 2a, this results in a length 45 of 127 mm. Returning to FIG. 7, the spraying subsystem is located in the centre of the enclosure, so distance 97 is 234 mm. Turning to FIG. 2b, the distance 49 and 51 between the edges of the pots is 117 mm, and distance 47 is 50 mm.

In operation, the resting or low level of the nutrient solution is around 1″ below the pots 108. During flooding, the level of the nutrient solution rises to around 2″ below the level of the lid. The enclosure is flooded for thirty minutes every hour and a half (i.e. the enclosure is flooded from 1200-1230, and then drained to the lower level, and then flooded again at 1400).

Returning to FIG. 7, there is a spray subsystem 110 that is mounted on a riser 112 and has spray heads 114 dispersed among the pots 108 as seen in FIG. 4. The spray heads are located inside the enclosure, approximately 99 mm (4″) below the level of the lid. In the early stages of plant growth the spray lasts for 30 seconds every five minutes, after one week the spraying is adjusted to 30 seconds every 10 minutes, and around week 3 or 4 the spray is adjusted to 20 seconds every thirty minutes. The spraying only occurs during times when the enclosure is not flooded.

Turning to FIG. 4, there is a water pump 85 that supplies the spray subsystem. Length 77, measured from the outside of the supply tubes, is 473 mm. Distance 83 is 109 mm, and distance 75 is 232 mm.

There is an oxygenation system 116, which is made of a porous flexible tube and is spread to cover the bottom of the enclosure as illustrated in FIG. 3. This oxygenation system is configured to create a constant stream of small bubbles throughout the enclosure. Turning to FIG. 3, length 67 of the bottom of the enclosure is 461 mm, and the top has a dimension of 610 mm. In this embodiment, the porous flexible tube has a diameter 51 of 120 mm, the distance from the centre of the enclosure to the inner ring is approximately 45 mm, the distance 59 from the inner ring to the second ring is approximately 73 mm, and the distance 65 from the second ring to the outer ring is approximately 59 mm.

Lighting is provided by Heliospectra® LED lights. In a first embodiment, the lights have a spectrum recipe of 10% green, 40-60% blue and violet and 30-50% yellow to red spectrum. The spectrum recipe can be varied, depending upon the plants growth stage and the plant strain. The lighting is located 3′ above the lids, (which will be approximately 2′ above the canopy if the plants being to flower at approximately 12″ in height).

Hydrotron®, an expanded ball clay manufactured specifically for hydroponic cultivation, is used to hold the plants upright in pots 108. Hydroton® is pH stabilized and almost completely inert.

In another embodiment, the spraying system in FIG. 7 is replaced with a top spraying system as illustrated in FIG. 5. Turning to FIG. 5, in this embodiment distance 154 between the spray heads is 225 mm, distance 156 is 161 mm, and distance 158 between the supply lines is 110 mm.

### Test Results

Experiments have shown significant increase in root growth and plant health resulting from use of the described system compared to a control DWC system.

The test results below were obtained under the following general conditions: humidity, temperature, water temperature, pH, EC (electrical conductivity) and TDS (total dissolved salts) were the same for all tests, and were measured daily and corrected as needed. Humidity in the growing room was kept between 55% and 70% and the temperature between 24° C. to 29° C. The nutrient solution's pH was kept between 5.8 and 6.3. Two pedestal fans were used for air circulation purposes, and the air pump ran continuously supplying oxygen to the roots. The light was adjusted to have 18 hours a day of light and 6 hours of dark. For the first two days, only water was circulated, then for a few days nutrient was added keeping the TDS at less than 200 ppm. The TDS was increased to 300 ppm, and in week 6 the nutrient solution was adjusted to a pre-flowering stage nutrient with a TDS of 450 ppm. The conditions in this paragraph were the same for all tests.

EC, electrical conductivity, is a measure of the dissolved salts in the solution. TDS is the total dissolved salts. The salt in the solution is important because too high of a salt content poisons the plant, while too low of a (nutrient) salt content indicates that the plant is not receiving sufficient nutrients.

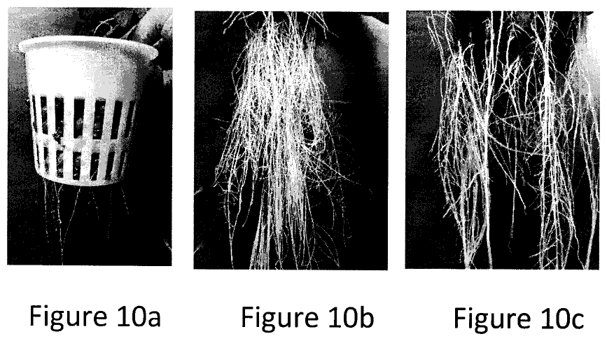

Tests FIGS. 10a to 10c show representative results from using different spray systems. FIG. 10a shows results after 30 days of growth using a DWC system as a control.

FIG. 100b shows the growth in roots after 30 days using the same system as in FIG. 7 with the substitution of a spraying system (as seen in FIG. 6) above the enclosure (a low pressure sprayer was situated at the top of the net pot close to the plant stem/crown).

FIG. 10c shows the growth in roots after 30 days using the same system as in FIG. 7 keeping the use of a spraying system inside the enclosure (360 degree sprayers installed on top of the riser and connected to small submersible pumps).

The results from both FIGS. 10b and 10c are markedly superior to the results seen in FIG. 10a.

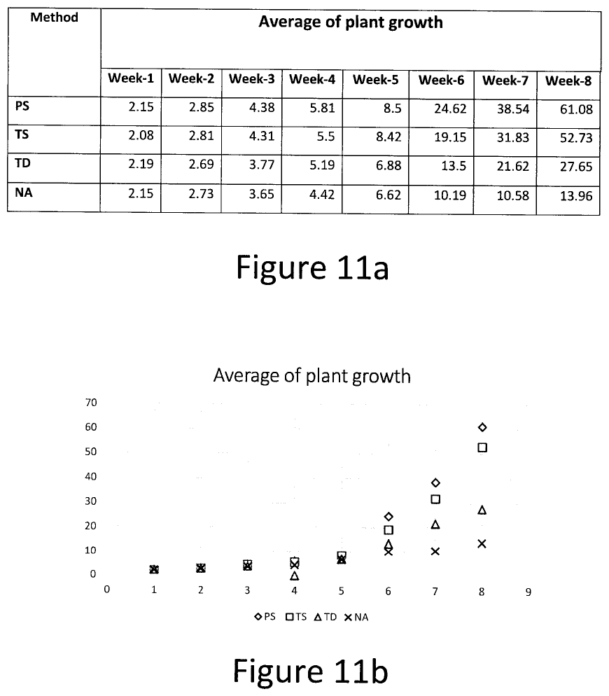

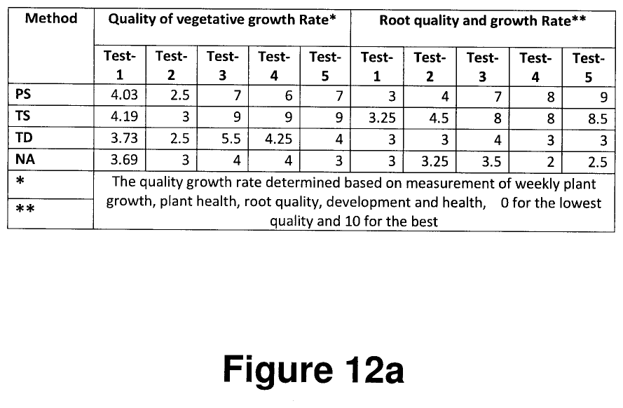

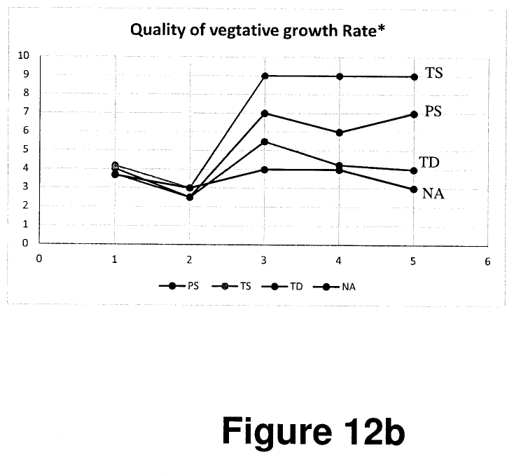

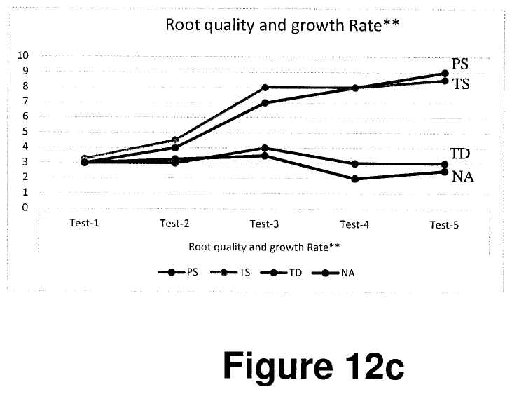

The results from the test are given in FIGS. 11a and 11b. In FIG. 11a, PS indicates use of the same system as in FIG. 7 keeping the use of a spraying system inside the enclosure (360 degree sprayers installed on top of the riser and connected to small submersible pumps); TS uses the same system as in FIG. 7 with the substitution of a spraying system (as seen in FIG. 6) above the enclosure (a low pressure sprayer was situated at the top of the net pot close to the plant stem/crown); TD indicates use of the same system as in FIG. 7 with the substitution of a dripper ring system (as illustrated in FIG. 6) above the enclosure (a dripping ring situated at the top of the net pot close to the plant stem/crown); and NA indicates the DWC control.

The results in table 11a are average growth of the plant in centimeters, measured from the crown (top of the root) to the top of the plant. Each test method (PS, TS, TD and NA) had 130 plants in the test. The results from table 11a are charted in graph 10b.

As may be seen from table 11a and graph 11b, the average plant growth in PS and TS were much greater than for the control NA. (TD was only marginally better than the control NA).

Further results from the same test are given in table 12a and charts 12b and 12c. PS, TS, TD and NA have the same meaning as given for table 11a. Table 12a shows the average vegetative growth and the quality of root. These measurements are qualitive assessments, rated on a scale from 1-10, and are known to persons skilled in the art. Each “Test” in the chart represents a single run through the experiment with a new batch of 130 plants. The assessments of average vegetative growth and the quality of root were made on a weekly basis, and the results were averaged to obtain the results in table 12a.

As may be seen from graphs 12b and 12c, average vegetative growth and the quality of root were markedly superior for the tests using the PS and TS methods and apparatus compared to the control NA. (TD was only marginally better than the control NA).

Conduits

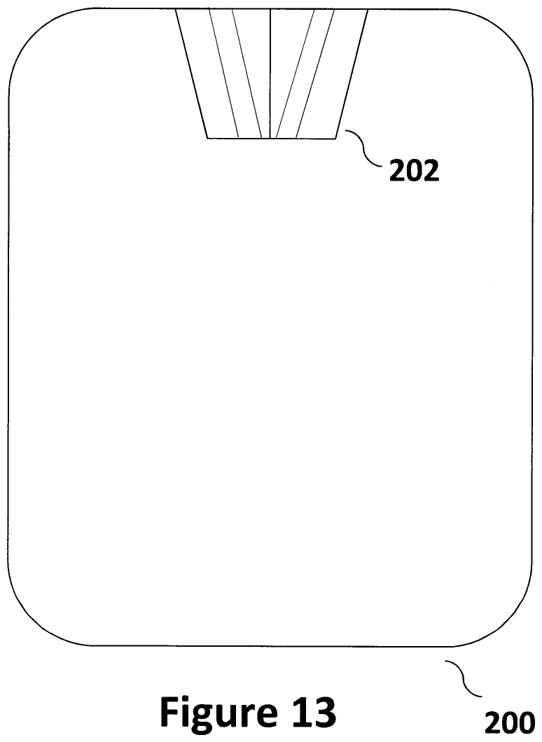

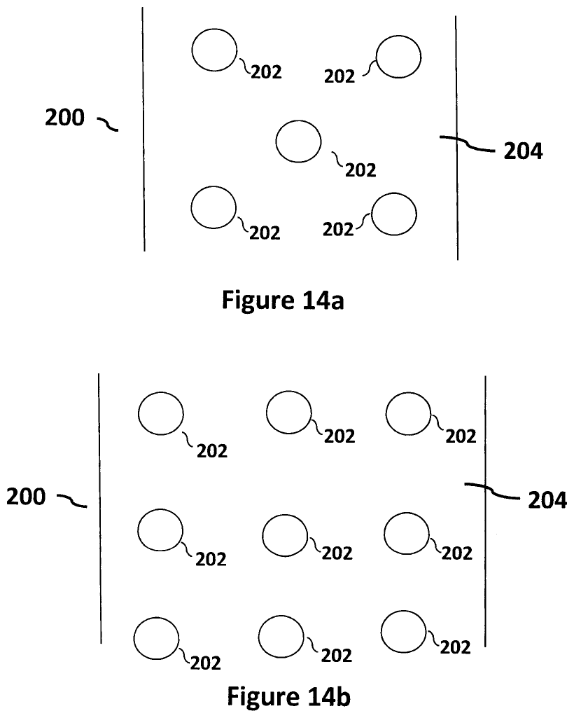

In a further embodiment of the invention, the nutrient solution passes through a conduit rather than a series of enclosures. FIG. 13 is a cross-sectional view of one example of such a conduit. Turning to FIG. 13, there is a conduit 200 that is suitable for the passage of a nutrient solution. There are a number of net pots 202 pierced through the top of the conduit, capable of holding a plant. While the conduit may be circular in the cross-section, it may take any suitable form. In particular, if the cross-sectional shape has a flat top surface and a flat bottom surface, as illustrated in FIGS. 14a and 14b, the top surface of the conduit 204 may accommodate a number of net pots 202. In FIG. 14a, the net pots 202 are offset to allow a greater number of net pots 202 along the axial length of the conduit.

These conduits otherwise employ the setup and methods of use described above. Specifically, the oxygenation system, spraying subsystems, control systems, lighting systems, and methods of operation (including flooding schedules and spraying schedules), and humidity and temperature conditions described above may all be used with a conduit system.

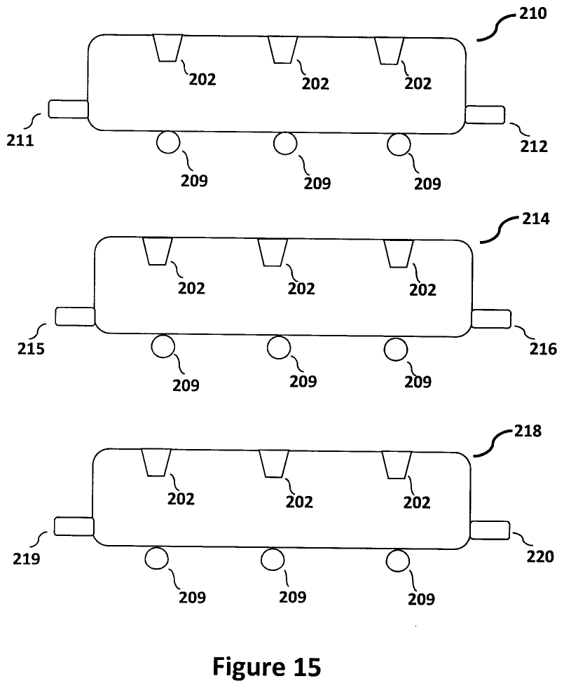

The conduits may be effectively deployed in a growing space in stacks to allow for efficient use of space in three dimensions. Turning to FIG. 15, there are conduits 210, 214 and 218, resting on supports 209, with net pots 202, which have inlets for the nutrient solution 211, 215 and 219 and outlets for the nutrient solution 212, 216 and 220. In an alternative arrangement, outlet 212 is connected to inlet 215 and outlet 216 is connected to inlet 219, so that nutrient solution passes from conduit 210 through conduits 214 and through conduit 218.

Placement of Lighting System

As described above, the lighting system whether used with an enclosure or a conduit may be located above the plants (or equivalently above the top of the enclosure or conduit). Alternatively, the lighting system may be placed to the side of the enclosure or conduit (equivalently, to the side of the plants), resulting in the flowering plants growing out towards the lights, creating a wall of flowering plants from which it is easier to harvest than from plants that growing an upright position.

The invention is not intended to be limited to the embodiments described herein, but rather the invention is intended to be applied widely within the scope of the inventive concept as defined in the specification as a whole including the appended claims.

1-46. (canceled)

47. A system for growing fruiting or flowering plants comprising:
an enclosure with an opening at the top;
a lid for the enclosure with at least one net pot pierced therethrough, the lid being sized to close the opening of the enclosure and the net pot being capable of holding a plant;
a liquid inlet for feeding a nutrient solution into the enclosure;
a liquid outlet for removing said nutrient solution from the enclosure;
a liquid nutrient circulation subsystem to circulate said nutrient solution through said enclosure through said liquid inlet and liquid outlet;
an oxygenation subsystem to oxygenate the nutrient solution while the nutrient solution is in the enclosure;
a spraying subsystem configured to spray the nutrient solution on the plant when said plant is held in the net pot;
the liquid nutrient subsystem further comprising a first pump to control the flow rate of said nutrient solution into the enclosure, and a valve connected to the liquid outlet to control the flow rate of said nutrient solution out of the enclosure, and a sensor in the enclosure that can detect if the nutrient solution in the enclosure has reached a set height;
a first control system in operative communication with said first pump and said valve and said sensor, said first control system being configured to raise and lower the height of nutrient solution in the enclosure to the set height at a first pre-determined schedule;
a second control system in operative communication with said spraying subsystem, said second control system being configured to activate the spraying subsystem for predetermined lengths of times at a second pre-determined schedule.

48. The system of claim 47 where the enclosure is shaped so the top of the enclosure overhangs the bottom of the enclosure on all sides.

49. The system of claim 48 where the spraying subsystem comprises multiple spraying nozzles located below the lid of the enclosure and situated so that each net pot is sprayed by at least 2 spraying nozzles.

50. The system of claim 49 where the first control system is configured to raise the height of nutrient solution to the set height for twenty to forty minutes every two hours, and the second control system is configured to activate the spraying subsystem to: in the seedling stage spray for around 20-40 seconds every five minutes, once the early vegetative stage is reached spray for around 20-40 seconds every 10 minutes, once the pre-flowering stage is reached spray for around 15-30 seconds every thirty minutes, and once the harvesting stage is reached spray for around 5-10 seconds every five minutes.

51. The system of claim 49 where the spraying subsystem comprises at least one spraying device located above the top of said plant when said plant is held in the net pot.

52. The system of claim 51 where the spraying device is a low pressure sprayer.

53. The system of claim 52, where the first control system is configured to raise the height of a nutrient solution to the set height for twenty to forty minutes every two hours, and the second control system is configured to activate the spraying subsystem for around 30 to 120 minutes for every 120 minutes.

54. The system of claim 53, where the first control system is configured to raise the height of nutrient solution to the set height for thirty minutes every two hours, the second control system is configured to activate the spraying subsystem for around 30 minutes for every 120 minutes.

55. The system of claim 54, further comprising a lighting subsystem and where the lighting subsystem has a light spectrum of around 10% green, around 40-60% blue and violet and around 30-50% yellow to red spectrum and from the seedling up to the flowering stage the lighting is 18 hours of light and 6 hours of dark per day, and at the flowering stage through harvesting the lighting is 12 hours of light and 12 hours of dark per day.

56. The system of claim 49 where the spraying subsystem comprises at least one spraying device located to be near the crown of said plant when said plant is held in the net pot, and the spraying device is a dripper ring or a low pressure sprayer.

57. A system for growing fruiting or flowering plants comprising a plethora of systems of claim 53, where the liquid nutrient is pumped from a reservoir through the plethora of systems of claim 53 and back into the reservoir.

58. The system of claim 57 where the liquid nutrient is pumped from a reservoir through the plethora of systems of claim 7 in series.

59. A method for growing fruiting or flowering plants comprising:
Placing at least one seedling of a plant in a net pot in an hydroponics apparatus, where the hydroponics apparatus comprises:
An enclosure with an opening at the top; a lid for the enclosure with at least one net pot pierced therethrough, the lid being sized to close the opening of the enclosure and the net pot being capable of holding a plant; a liquid inlet for feeding a nutrient solution into the enclosure; A liquid outlet for removing said nutrient solution from the enclosure; a liquid nutrient circulation subsystem to circulate said nutrient solution through said enclosure through said liquid inlet and liquid outlet; an oxygenation subsystem to oxygenate the nutrient solution while the nutrient solution is in the enclosure; a spraying subsystem configured to spray the nutrient solution on the plant when said plant is held in the net pot; the liquid nutrient subsystem further comprising a first pump to control the flow rate of said nutrient solution into the enclosure, and a valve connected to the liquid outlet to control the flow rate of said nutrient solution out of the enclosure, and a sensor in the enclosure that can detect if the nutrient solution in the enclosure has reached a set height; a first control system in operative communication with said first pump and said valve and said sensor; a second control system in operative communication with said spraying subsystem, and a lighting subsystem; where said first control system is configured to raise and lower the height of nutrient solution in the enclosure to the set height at a first pre-determined schedule such that the roots of the seedling are substantially covered when the nutrient solution in the enclosure is at its highest point; and said second control system being configured to activate the spraying subsystem for predetermined lengths of times at a second pre-determined schedule.

60. The method of 59, where the configuration of the first control system and the configuration of the second control system are varied with the growth stage of the plant.

61. The method of 60, where the first control system is configured to raise the height of nutrient solution to the set height for twenty to forty minutes every two hours, and the second control system is configured to activate the spraying subsystem to: in the seedling stage spray for around 20-40 seconds every five minutes, once the early vegetative stage is reached spray for around 20-40 seconds every 10 minutes, once the pre-flowering stage is reached spray for around 15-30 seconds every thirty minutes, and once the harvesting stage is reached spray for around 5-10 seconds every five minutes.

62. The method of claim 61, where the lighting subsystem has a light spectrum of around 10% green, around 40-60% blue and violet and around 30-50% yellow to red spectrum and from the seedling up to the flowering stage the lighting is around 18 hours of light and around 6 hours of dark per day, and at the flowering stage through harvesting the lighting is around 12 hours of light and around 12 hours of dark per day.

63. The method of claim 62, where the plants are kept in the same growing location during the growth of the plant from seedling to harvesting.

64. A method for growing fruiting or flowering plants comprising:
Substantially immersing the roots of the plant in a nutrient solution on a first periodic basis while oxygenating the nutrient solution, while spraying the roots of the plant on a second periodic basis when the roots are not immersed and while lighting the plant on a third periodic basis.

65. The method of 64, where the first periodic basis comprises substantially immersing the roots of the plant for twenty to forty minutes every two hours, and the second periodic basis comprises: using a micro-sprayer nozzle, in the seedling stage spraying for around 20-40 seconds every five minutes, once the early vegetative stage is reached spraying around 20-40 seconds every 10 minutes, once the pre-flowering stage is reached spraying around 15-30 seconds every thirty minutes, and once the harvesting stage is reached spraying around 5-10 seconds every five minutes.

66. The method of 65, where the plants are not moved from one growing location to another during the growth of the plant from seedling to harvesting.
